(19) United States
(12) Patent Application Publication
(10) Pub. No.: US 2014/0198121 A1
(43) Pub. Date: Jul. 17, 2014

(54) SYSTEM AND METHOD FOR AVATAR GENERATION, RENDERING AND ANIMATION

(71) Applicants: Xiaofeng Tong, Beijing (CN); Wenlong Li, Beijing (CN); Yangzhou Du, Beijing (CN); Wei Hu, Beijing (CN); Jianguo Li, Beijing (CN); Yimin Zhang, Beijing (CN)

(72) Inventors: Xiaofeng Tong, Beijing (CN); Wenlong Li, Beijing (CN); Yangzhou Du, Beijing (CN); Wei Hu, Beijing (CN); Jianguo Li, Beijing (CN); Yimin Zhang, Beijing (CN)

(21) Appl. No.: 13/997,265

(22) PCT Filed: Apr. 9, 2012
(86) PCT No.: PCT/CN2012/000460

§ 371 Date: Nov. 22, 2013

(51) Int. Cl. G06T 11/60

(52) U.S. Cl. CPC G06T 11/60
USPC 345/581

(57) ABSTRACT

A video communication system that replaces actual live images of the participating users with animated avatars. The system allows generation, rendering and animation of a two-dimensional (2-D) avatar of a user's face. The 2-D avatar represents a user's basic face shape and key facial characteristics, including, but not limited to, position and shape of the eyes, nose, mouth, and face contour. The system further allows adaptive rendering for displaying allow different scales of the 2-D avatar to be displayed on associated different sized displays of user devices.

### FIELD

The present disclosure relates to video communication and interaction, and, more particularly, to a system and method for avatar generation, animation and rendering for use in video communication and interaction.

### BACKGROUND

The increasing variety of functionality available in mobile devices has spawned a desire for users to communicate via video in addition to simple calls. For example, users may initiate “video calls,” “videoconferencing,” etc., wherein a camera and microphone in a device transmits audio and real-time video of a user to one or more other recipients such as other mobile devices, desktop computers, videoconferencing systems, etc. The communication of real-time video may involve the transmission of substantial amounts of data (e.g., depending on the technology of the camera, the particular video codec employed to process the real time image information, etc.). Given the bandwidth limitations of existing 2G/3G wireless technology, and the still limited availability of emerging 4G wireless technology, the proposition of many device users conducting concurrent video calls places a large burden on bandwidth in the existing wireless communication infrastructure, which may impact negatively on the quality of the video call.

### BRIEF DESCRIPTION OF DRAWINGS

Features and advantages of various embodiments of the claimed subject matter will become apparent as the following Detailed Description proceeds, and upon reference to the Drawings, wherein like numerals designate like parts, and in which:

FIG. 1A illustrates an example device-to-device system consistent with various embodiments of the present disclosure;

FIG. 1B illustrates an example virtual space system consistent with various embodiments of the present disclosure;

FIG. 2 illustrates an example device in consistent with various embodiments of the present disclosure;

FIG. 3 illustrates an example face detection module consistent with various embodiments of the present disclosure;

FIGS. 4A-4C illustrate example facial marking parameters and generation of an avatar consistent with at least one embodiment of the present disclosure;

FIG. 5 illustrates an example avatar control module and selection module consistent with various embodiments of the present disclosure;

FIG. 6 illustrates an example system implementation consistent with at least one embodiment of the present disclosure; and

FIG. 7 is a flowchart of example operations consistent with at least one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Some systems and methods allow communication and interaction between users in which a user may choose a particular avatar to represent him or herself. Avatar models and the animation of such may be critical to user experience during communication. In particular, it may be desirable to have relatively quick animation response (in real-time or near real-time) and accurate and/or vivid representations of a user's face and facial expressions.

Some systems and methods allow for the generation and rendering of three-dimensional (3-D) avatar models for use during communication. For example, some known methods include laser scan, model-based photograph fitting, manual generation by a graphic designer or artist, etc. However, these known 3-D avatar generation systems and methods may have drawbacks. In particular, in order to keep model animation relatively smooth during communication, a 3-D avatar model may generally include thousands of vertex and triangles points, and rendering of a 3-D avatar model may require substantial computational input and horsepower. Additionally, the generation of a 3-D avatar may also require manual revision to improve visional effect when used during communication and interaction, and it may be difficult for a common user to create a relatively robust 3-D avatar model by him or herself.

Many users may utilize mobile computing devices, such as, for example, a smartphone, to communicate and interact with avatars. However, mobile computing devices may have limited computing resources and/or storage, and, as such, may not be fully capable of providing a satisfactory avatar communication and interaction experience for the user, particularly with the use of 3-D avatars.

By way of overview, the present disclosure is generally directed to a system and method for video communication and interaction using interactive avatars. A system and method consistent with the present disclosure generally provides avatar generation and rendering for use in video communication and interaction between local and remote users on associated local and remote user devices. More specifically, the system allows generation, rendering and animation of a two-dimensional (2-D) avatar of a user's face, wherein the 2-D avatar represents a user's basic face shape and key facial characteristics, including, but not limited to, position and shape of the eyes, nose, mouth, and face contour. The system is further configured to provide avatar animation based at least in part on the detected key facial characteristics of the user in real-time or near real-time during active communication and interaction. The system and method further provide adaptive rendering for displaying various scales of the 2-D avatar on a display of a user device during active communication and interaction. More specifically, the system and method may be configured to identify a scaling factor to of the 2-D avatar corresponding to different sized displays of user devices, thereby preventing distortion of the 2-D avatar when displayed on a variety of displays of user devices.

In one embodiment, an application is activated in a device coupled to a camera. The application may be configured to allow a user to generate a 2-D avatar based on user's face and facial characteristics for display on a remote device, in a virtual space, etc. The camera may be configured to start capturing images and facial detection is then performed on the captured images, and facial characteristics are determined Avatar selection is then performed, wherein a user may select between a predefined 2-D avatar and generation of a 2-D avatar based on the facial characteristics of the user. Any detected face/head movements, including movement of one or more of the user's facial characteristics, including, but not limited to, eyes, nose and mouth and/or changes in facial features are then converted into parameters usable for animating the 2-D avatar on the at least one other device, within the virtual space, etc.

The device may then be configured to initiate communication with at least one other device, a virtual space, etc. For example, the communication may be established over a 2G, 3G, 4G cellular connection. Alternatively, the communication may be established over the Internet via a WiFi connection. After the communication is established, scaling factors are determined in order to allow the selected 2-D avatar to be properly displayed on the at least one other device during communication and interaction between the devices. At least one of the avatar selection, avatar parameters and scaling factors may then be transmitted. In one embodiment at least one of a remote avatar selection or remote avatar parameters are received. The remote avatar selection may cause the device to display an avatar, while the remote avatar parameters may cause the device to animate the displayed avatar. Audio communication accompanies the avatar animation via known methods.

A system and method consistent with the present disclosure may provide an improved experience for a user communicating and interacting with other users via a mobile computing device, such as, for example, a smartphone. In particular, when compared to known 3-D avatar systems and methods, the present system provides the advantage of utilizing a simpler 2-D avatar model generation and rendering method, which requires much less computational input and power. Additionally, the present system provides real-time or near real-time animation of the 2-D avatar.

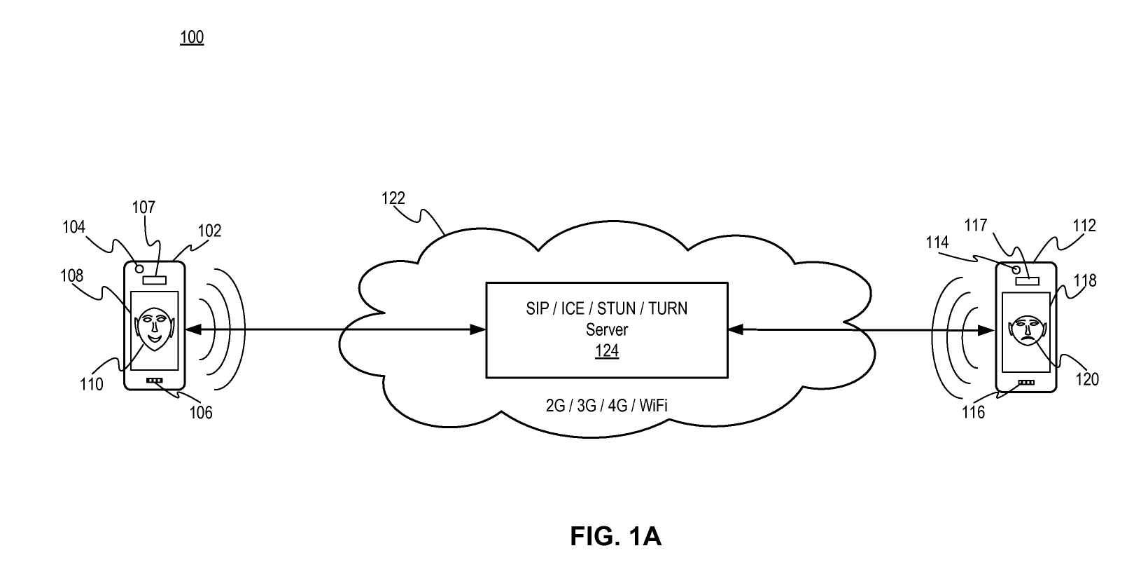

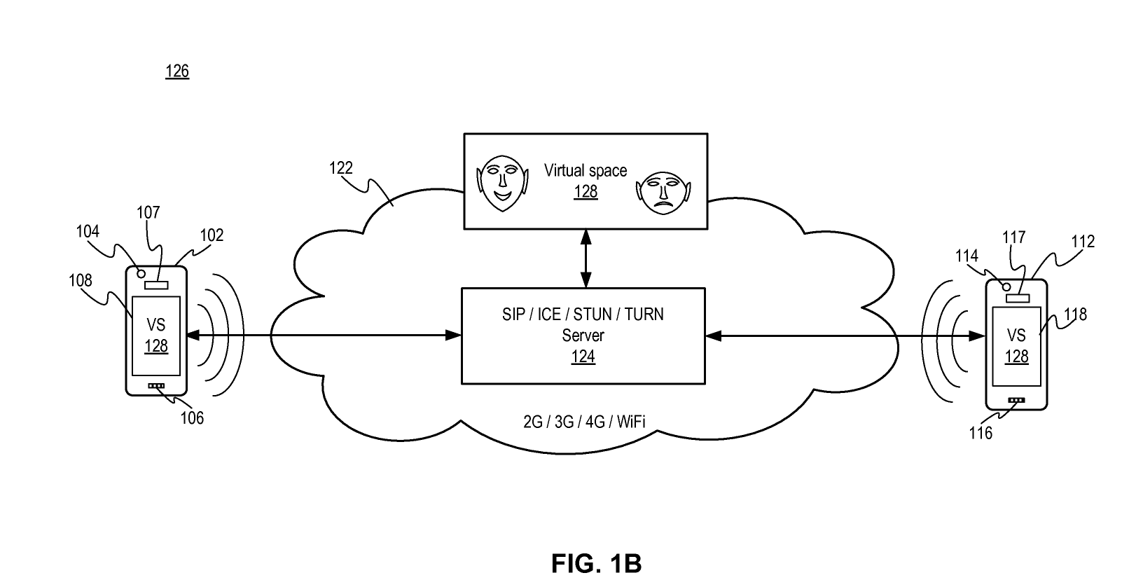

FIG. 1A illustrates device-to-device system 100 consistent with various embodiments of the present disclosure. The system 100 may generally include devices 102 and 112 communicating via network 122. Device 102 includes at least camera 104, microphone 106 and display 108. Device 112 includes at least camera 114, microphone 116 and display 118. Network 122 includes at least one server 124.

Devices 102 and 112 may include various hardware platforms that are capable of wired and/or wireless communication. For example, devices 102 and 112 may include, but are not limited to, videoconferencing systems, desktop computers, laptop computers, tablet computers, smart phones, (e.g., iPhones®, Android®-based phones, Blackberries®, Symbian®-based phones, Palm®-based phones, etc.), cellular handsets, etc.

Cameras 104 and 114 include any device for capturing digital images representative of an environment that includes one or more persons, and may have adequate resolution for face analysis of the one or more persons in the environment as described herein. For example, cameras 104 and 114 may include still cameras (e.g., cameras configured to capture still photographs) or video cameras (e.g., cameras configured to capture moving images comprised of a plurality of frames). Cameras 104 and 114 may be configured to operate using light in the visible spectrum or with other portions of the electromagnetic spectrum not limited to the infrared spectrum, ultraviolet spectrum, etc. Cameras 104 and 114 may be incorporated within devices 102 and 112, respectively, or may be separate devices configured to communicate with devices 102 and 112 via wired or wireless communication. Specific examples of cameras 104 and 114 may include wired (e.g., Universal Serial Bus (USB), Ethernet, Firewire, etc.) or wireless (e.g., WiFi, Bluetooth, etc.) web cameras as may be associated with computers, video monitors, etc., mobile device cameras (e.g., cell phone or smart phone cameras integrated in, for example, the previously discussed example devices), integrated laptop computer cameras, integrated tablet computer cameras (e.g., iPad®, Galaxy Tab®, and the like), etc.

Devices 102 and 112 may further include microphones 106 and 116. Microphones 106 and 116 include any devices configured to sense sound. Microphones 106 and 116 may be integrated within devices 102 and 112, respectively, or may interact with the devices 102, 112 via wired or wireless communication such as described in the above examples regarding cameras 104 and 114. Displays 108 and 118 include any devices configured to display text, still images, moving images (e.g., video), user interfaces, graphics, etc. Displays 108 and 118 may be integrated within devices 102 and 112, respectively, or may interact with the devices via wired or wireless communication such as described in the above examples regarding cameras 104 and 114.

In one embodiment, displays 108 and 118 are configured to display avatars 110 and 120, respectively. As referenced herein, an Avatar is defined as graphical representation of a user in either two-dimensions (2-D) or three-dimensions (3-D). Avatars do not have to resemble the looks of the user, and thus, while avatars can be lifelike representations they can also take the form of drawings, cartoons, sketches, etc. As shown, device 102 may display avatar 110 representing the user of device 112 (e.g., a remote user), and likewise, device 112 may display avatar 120 representing the user of device 102. As such, users may view a representation of other users without having to exchange large amounts of information that are generally involved with device-to-device communication employing live images.

Network 122 may include various second generation (2G), third generation (3G), fourth generation (4G) cellular-based data communication technologies, Wi-Fi wireless data communication technology, etc. Network 122 includes at least one server 124 configured to establish and maintain communication connections when using these technologies. For example, server 124 may be configured to support Internet-related communication protocols like Session Initiation Protocol (SIP) for creating, modifying and terminating two-party (unicast) and multi-party (multicast) sessions, Interactive Connectivity Establishment Protocol (ICE) for presenting a framework that allows protocols to be built on top of bytestream connections, Session Traversal Utilities for Network Access Translators, or NAT, Protocol (STUN) for allowing applications operating through a NAT to discover the presence of other NATs, IP addresses and ports allocated for an application's User Datagram Protocol (UDP) connection to connect to remote hosts, Traversal Using Relays around NAT (TURN) for allowing elements behind a NAT or firewall to receive data over Transmission Control Protocol (TCP) or UDP connections, etc.

FIG. 1B illustrates a virtual space system 126 consistent with various embodiments of the present disclosure. The system 126 may include device 102, device 112 and server 124. Device 102, device 112 and server 124 may continue to communicate in the manner similar to that illustrated in FIG. 1A, but user interaction may take place in virtual space 128 instead of in a device-to-device format. As referenced herein, a virtual space may be defined as a digital simulation of a physical location. For example, virtual space 128 may resemble an outdoor location like a city, road, sidewalk, field, forest, island, etc., or an inside location like an office, house, school, mall, store, etc.

Users, represented by avatars, may appear to interact in virtual space 128 as in the real world. Virtual space 128 may exist on one or more servers coupled to the Internet, and may be maintained by a third party. Examples of virtual spaces include virtual offices, virtual meeting rooms, virtual worlds like Second Life®, massively multiplayer online role-playing games (MMORPGs) like World of Warcraft®, massively multiplayer online real-life games (MMORLGs), like The Sims Online®, etc. In system 126, virtual space 128 may contain a plurality of avatars corresponding to different users. Instead of displaying avatars, displays 108 and 118 may display encapsulated (e.g., smaller) versions of virtual space (VS) 128. For example, display 108 may display a perspective view of what the avatar corresponding to the user of device 102 “sees” in virtual space 128. Similarly, display 118 may display a perspective view of what the avatar corresponding to the user of device 112 “sees” in virtual space 128. Examples of what avatars might see in virtual space 128 may include, but are not limited to, virtual structures (e.g., buildings), virtual vehicles, virtual objects, virtual animals, other avatars, etc.

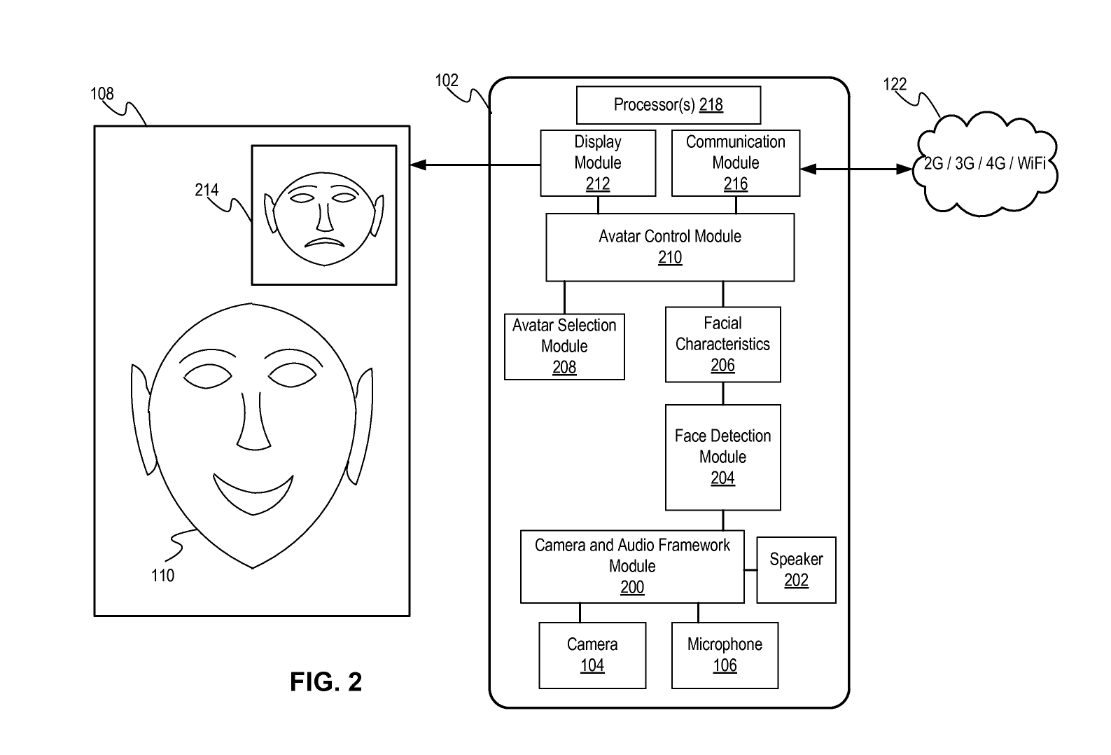

FIG. 2 illustrates an example device 102 in accordance with various embodiments of the present disclosure. While only device 102 is described, device 112 (e.g., remote device) may include resources configured to provide the same or similar functions. As previously discussed, device 102 is shown including camera 104, microphone 106 and display 108. The camera 104 and microphone 106 may provide input to a camera and audio framework module 200. The camera and audio framework module 200 may include custom, proprietary, known and/or after-developed audio and video processing code (or instruction sets) that are generally well-defined and operable to control at least camera 104 and microphone 106. For example, the camera and audio framework module 200 may cause camera 104 and microphone 106 to record images and/or sounds, may process images and/or sounds, may cause images and/or sounds to be reproduced, etc. The camera and audio framework module 200 may vary depending on device 102, and more particularly, the operating system (OS) running in device 102. Example operating systems include iOS®, Android®, Blackberry® OS, Symbian®, Palm® OS, etc. A speaker 202 may receive audio information from camera and audio framework module 200 and may be configured to reproduce local sounds (e.g., to provide audio feedback of the user's voice) and remote sounds (e.g., the sound of the other parties engaged in a telephone, video call or interaction in a virtual place).

The device 102 may further include a face detection module 204 configured to identify and track a head, face and/or facial region within image(s) provided by camera 104 and to determine one or more facial characteristics of the user (i.e., facial characteristics 206). For example, the face detection module 204 may include custom, proprietary, known and/or after-developed face detection code (or instruction sets), hardware, and/or firmware that are generally well-defined and operable to receive a standard format image (e.g., but not limited to, a RGB color image) and identify, at least to a certain extent, a face in the image.

The face detection module 204 may also be configured to track the detected face through a series of images (e.g., video frames at 24 frames per second) and to determine a head position based on the detected face, as well as changes, such as, for example, movement, in facial characteristics of the user (e.g., facial characteristics 206). Known tracking systems that may be employed by face detection module 204 may include particle filtering, mean shift, Kalman filtering, etc., each of which may utilize edge analysis, sum-of-square-difference analysis, feature point analysis, histogram analysis, skin tone analysis, etc.

The face detection module 204 may also include custom, proprietary, known and/or after-developed facial characteristics code (or instruction sets) that are generally well-defined and operable to receive a standard format image (e.g., but not limited to, a RGB color image) and identify, at least to a certain extent, one or more facial characteristics 206 in the image. Such known facial characteristics systems include, but are not limited to, the CSU Face Identification Evaluation System by Colorado State University, standard Viola-Jones boosting cascade framework, which may be found in the public Open Source Computer Vision (OpenCV™) package.

As discussed in greater detail herein, facial characteristics 206 may include features of the face, including, but not limited to, the location and/or shape of facial landmarks such as eyes, nose, mouth, facial contour, etc., as well as movement of such landmarks. In one embodiment, avatar animation may be based on sensed facial actions (e.g., changes in facial characteristics 206). The corresponding feature points on an avatar's face may follow or mimic the movements of the real person's face, which is known as “expression clone” or “performance-driven facial animation.”

The face detection module 204 may also be configured to recognize an expression associated with the detected features (e.g., identifying whether a previously detected face is happy, sad, smiling, frown, surprised, excited, etc.)). Thus, the face detection module 204 may further include custom, proprietary, known and/or after-developed facial expression detection and/or identification code (or instruction sets) that is generally well-defined and operable to detect and/or identify expressions in a face. For example, the face detection module 204 may determine size and/or position of facial features (e.g., eyes, nose, mouth, etc.) and may compare these facial features to a facial feature database which includes a plurality of sample facial features with corresponding facial feature classifications (e.g. smiling, frown, excited, sad, etc.).

The device 102 may further include an avatar selection module 208 configured to allow a user of device 102 to select an avatar for display on a remote device. The avatar selection module 208 may include custom, proprietary, known and/or after-developed user interface construction code (or instruction sets) that are generally well-defined and operable to present different avatars to a user so that the user may select one of the avatars.

In one embodiment, the avatar selection module 208 may be configured to allow a user of the device 102 to select one or more predefined avatars stored within the device 102 or select an option of having an avatar generated based on detected facial characteristics 206 of the user. Both the predefined avatar and the generated avatar may be two-dimensional (2-D), wherein a predefined avatar is model-based and a generated 2-D avatar is sketch-based, as described in greater detail herein.

Predefined avatars may allow all devices to have the same avatars, and during interaction only the selection of an avatar (e.g., the identification of a predefined avatar) needs to be communicated to a remote device or virtual space, which reduces the amount of information that needs to be exchanged. A generated avatar may be stored within the device 102 for use during future communications. Avatars may be selected prior to establishing communication, but may also be changed during the course of an active communication. Thus, it may be possible to send or receive an avatar selection at any point during the communication, and for the receiving device to change the displayed avatar in accordance with the received avatar selection.

The device 102 may further include an avatar control module 210 configured to generate an avatar in response to a selection input from the avatar selection module 208. The avatar control module 210 may include custom, proprietary, known and/or after-developed avatar generation processing code (or instruction sets) that are generally well-defined and operable to generate a 2-D avatar based on the face/head position and/or facial characteristics 206 detected by face detection module 204.

The avatar control module 210 may further be configured to generate parameters for animating an avatar. Animation, as referred to herein, may be defined as altering the appearance of an image/model. A single animation may alter the appearance of a 2-D still image, or multiple animations may occur in sequence to simulate motion in the image (e.g., head turn, nodding, talking, frowning, smiling, laughing, etc.). A change in position of the detected face and/or facial characteristic 206 may be may converted into parameters that cause the avatar's features to resemble the features of the user's face.

In one embodiment the general expression of the detected face may be converted into one or more parameters that cause the avatar to exhibit the same expression. The expression of the avatar may also be exaggerated to emphasize the expression. Knowledge of the selected avatar may not be necessary when avatar parameters may be applied generally to all of the predefined avatars. However, in one embodiment avatar parameters may be specific to the selected avatar, and thus, may be altered if another avatar is selected. For example, human avatars may require different parameter settings (e.g., different avatar features may be altered) to demonstrate emotions like happy, sad, angry, surprised, etc. than animal avatars, cartoon avatars, etc.

The avatar control module 210 may include custom, proprietary, known and/or after-developed graphics processing code (or instruction sets) that are generally well-defined and operable to generate parameters for animating the avatar selected by avatar selection module 208 based on the face/head position and/or facial characteristics 206 detected by face detection module 204. For facial feature-based animation methods, 2-D avatar animation may be done with, for example, image warping or image morphing. Oddcast is an example of a software resource usable for 2-D avatar animation.

In addition, in system 100, the avatar control module 210 may receive a remote avatar selection and remote avatar parameters usable for displaying and animating an avatar corresponding to a user at a remote device. The avatar control module 210 may cause a display module 212 to display an avatar 110 on the display 108. The display module 212 may include custom, proprietary, known and/or after-developed graphics processing code (or instruction sets) that are generally well-defined and operable to display and animate an avatar on display 108 in accordance with the example device-to-device embodiment.

For example, the avatar control module 210 may receive a remote avatar selection and may interpret the remote avatar selection to correspond to a predetermined avatar. The display module 212 may then display avatar 110 on display 108. Moreover, remote avatar parameters received in avatar control module 210 may be interpreted, and commands may be provided to display module 212 to animate avatar 110.

The avatar control module 210 may further be configured to provide adaptive rendering of a remote avatar selection based on remote avatar parameters. More specifically, the avatar control module 210 may include custom, proprietary, known and/or after-developed graphics processing code (or instruction sets) that are generally well-defined and operable to adaptively render the avatar 110 so as to appropriately fit on the display 108 and prevent distortion of the avatar 110 when displayed to a user.

In one embodiment more than two users may engage in the video call. When more than two users are interacting in a video call, the display 108 may be divided or segmented to allow more than one avatar corresponding to remote users to be displayed simultaneously. Alternatively, in system 126, the avatar control module 210 may receive information causing the display module 212 to display what the avatar corresponding to the user of device 102 is “seeing” in virtual space 128 (e.g., from the visual perspective of the avatar). For example, the display 108 may display buildings, objects, animals represented in virtual space 128, other avatars, etc. In one embodiment, the avatar control module 210 may be configured to cause the display module 212 to display a “feedback” avatar 214. The feedback avatar 214 represents how the selected avatar appears on the remote device, in a virtual place, etc. In particular, the feedback avatar 214 appears as the avatar selected by the user and may be animated using the same parameters generated by avatar control module 210. In this way the user may confirm what the remote user is seeing during their interaction.

The device 102 may further include a communication module 216 configured to transmit and receive information for selecting avatars, displaying avatars, animating avatars, displaying virtual place perspective, etc. The communication module 216 may include custom, proprietary, known and/or after-developed communication processing code (or instruction sets) that are generally well-defined and operable to transmit avatar selections, avatar parameters and receive remote avatar selections and remote avatar parameters. The communication module 216 may also transmit and receive audio information corresponding to avatar-based interactions. The communication module 216 may transmits and receive the above information via network 122 as previously described.

The device 102 may further include one or more processor(s) 218 configured to perform operations associated with device 102 and one or more of the modules included therein.

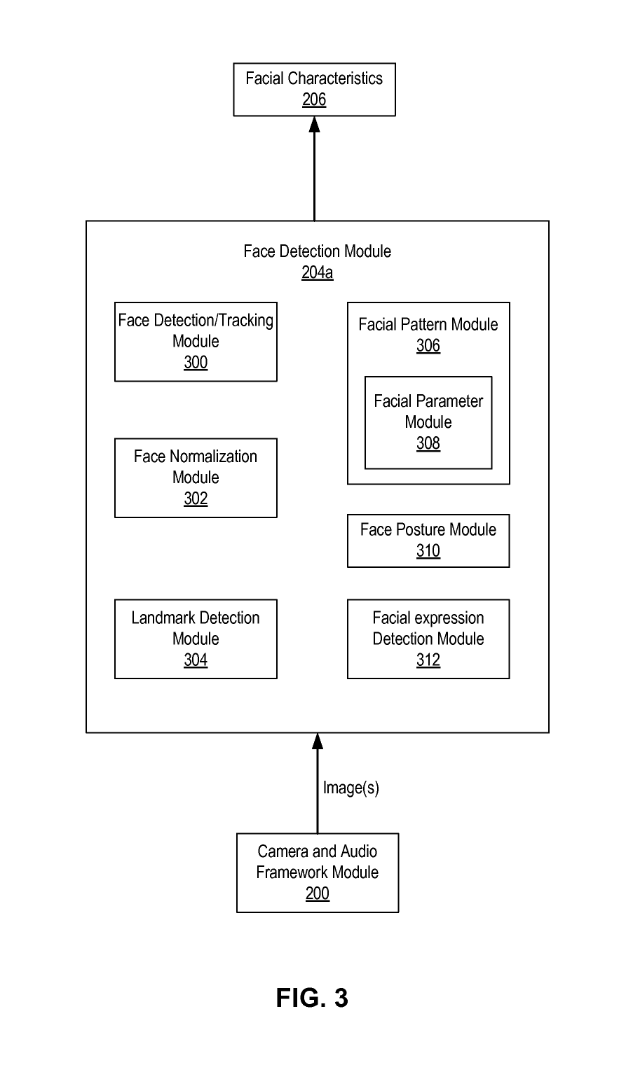

FIG. 3 illustrates an example face detection module 204a consistent with various embodiments of the present disclosure. The face detection module 204a may be configured to receive one or more images from the camera 104 via the camera and audio framework module 200 and identify, at least to a certain extent, a face (or optionally multiple faces) in the image. The face detection module 204a may also be configured to identify and determine, at least to a certain extent, one or more facial characteristics 206 in the image. The facial characteristics 206 may be generated based on one or more of the facial parameters identified by the face detection module 204a as described herein. The facial characteristics 206 may include may include features of the face, including, but not limited to, the location and/or shape of facial landmarks such as eyes, nose, mouth, facial contour, eyebrows, etc.

In the illustrated embodiment, the face detection module 204a may include a face detection/tracking module 300, a face normalization module 302, a landmark detection module 304, a facial pattern module 306, a facial parameter module 308, a face posture module 310, and a facial expression detection module 312. The face detection/tracking module 300 may include custom, proprietary, known and/or after-developed face tracking code (or instruction sets) that is generally well-defined and operable to detect and identify, at least to a certain extent, the size and location of human faces in a still image or video stream received from the camera 104. Such known face detection/tracking systems include, for example, the techniques of Viola and Jones, published as Paul Viola and Michael Jones, Rapid Object Detection using a Boosted Cascade of Simple Features, Accepted Conference on Computer Vision and Pattern Recognition, 2001. These techniques use a cascade of Adaptive Boosting (AdaBoost) classifiers to detect a face by scanning a window exhaustively over an image. The face detection/tracking module 300 may also track a face or facial region across multiple images.

The face normalization module 302 may include custom, proprietary, known and/or after-developed face normalization code (or instruction sets) that is generally well-defined and operable to normalize the identified face in the image. For example, the face normalization module 302 may be configured to rotate the image to align the eyes (if the coordinates of the eyes are known), nose, mouth, etc. and crop the image to a smaller size generally corresponding the size of the face, scale the image to make the distance between the eyes, nose and/or mouth, etc. constant, apply a mask that zeros out pixels not in an oval that contains a typical face, histogram equalize the image to smooth the distribution of gray values for the non-masked pixels, and/or normalize the image so the non-masked pixels have mean zero and standard deviation one.

The landmark detection module 304 may include custom, proprietary, known and/or after-developed landmark detection code (or instruction sets) that is generally well-defined and operable to detect and identify, at least to a certain extent, the various facial features of the face in the image Implicit in landmark detection is that the face has already been detected, at least to some extent. Optionally, some degree of localization may have been performed (for example, by the face normalization module 302) to identify/focus on the zones/areas of the image where landmarks can potentially be found. For example, the landmark detection module 304 may be based on heuristic analysis and may be configured to identify and/or analyze the relative position, size, and/or shape of the forehead, eyes (and/or the corner of the eyes), nose (e.g., the tip of the nose), chin (e.g. tip of the chin), eyebrows, cheekbones, jaw, and facial contour. The eye-corners and mouth corners may also be detected using Viola-Jones based classifier.

The facial pattern module 306 may include custom, proprietary, known and/or after-developed facial pattern code (or instruction sets) that is generally well-defined and operable to identify and/or generate a facial pattern based on the identified facial landmarks in the image. As may be appreciated, the facial pattern module 306 may be considered a portion of the face detection/tracking module 300.

The facial pattern module 306 may include a facial parameter module 308 configured to generate facial parameters of the user's face based, at least in part, on the identified facial landmarks in the image. The facial parameter module 308 may include custom, proprietary, known and/or after-developed facial pattern and parameter code (or instruction sets) that is generally well-defined and operable to identify and/or generate key points and associated edges connecting at least some of the key points based on the identified facial landmarks in the image.

As described in greater detail herein, the generation of a 2-D avatar by the avatar control module 210 may be based, at least in part, on the facial parameters generated by the facial parameter module 308, including the key points and associated connecting edges defined between the key points. Similarly, animation and rendering of a selected avatar, including both the predefined avatars and generated avatars, by the avatar control module 210 may be based, at least in part, on the facial parameters generated by the facial parameter module 308.

The face posture module 310 may include custom, proprietary, known and/or after-developed facial orientation detection code (or instruction sets) that is generally well-defined and operable to detect and identify, at least to a certain extent, the posture of the face in the image. For example, the face posture module 310 may be configured to establish the posture of the face in the image with respect to the display 108 of the device 102. More specifically, the face posture module 310 may be configured to determine whether the user's face is directed toward the display 108 of the device 102, thereby indicating whether the user is observing the content being displayed on the display 108.

The facial expression detection module 312 may include custom, proprietary, known and/or after-developed facial expression detection and/or identification code (or instruction sets) that is generally well-defined and operable to detect and/or identify facial expressions of the user in the image. For example, the facial expression detection module 312 may determine size and/or position of the facial features (e.g., forehead, chin, eyes, nose, mouth, cheeks, facial contour, etc.) and compare the facial features to a facial feature database which includes a plurality of sample facial features with corresponding facial feature classifications.

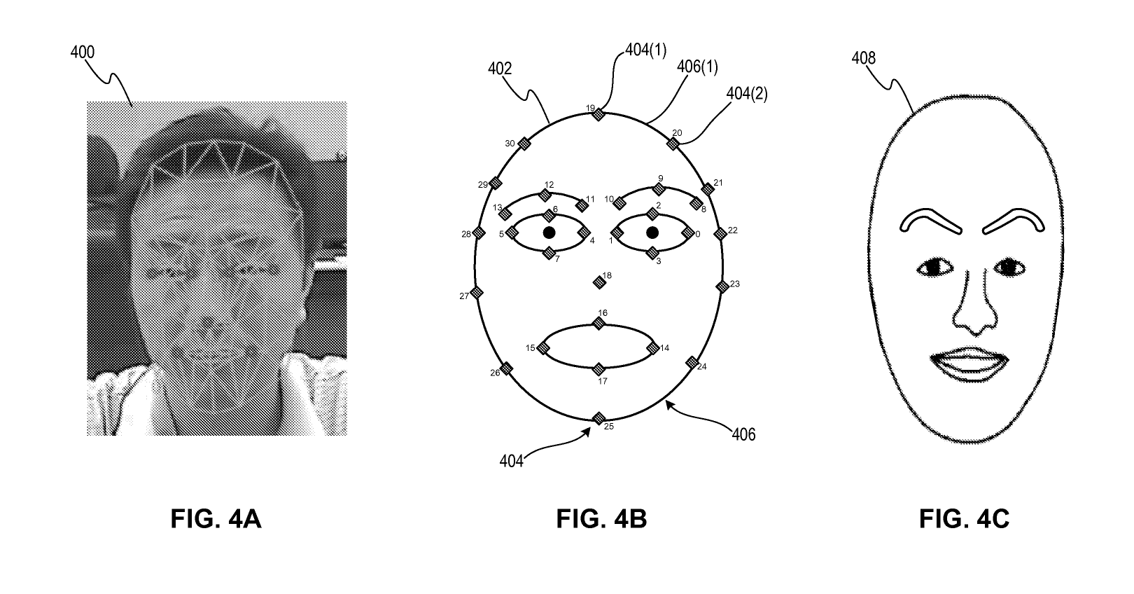

FIGS. 4A-4C illustrate example facial marking parameters and generation of an avatar consistent with at least one embodiment of the present disclosure. As shown in FIG. 4A, facial detection and tracking of an image 400 of a user are performed. As previously described, the face detection module 204 (including the face detection/tracking module 300, a face normalization module 302, and/or landmark detection module 304, etc.) may be configured to detect and identify the size a location of the user's face, normalize the identified face, and/or detect and identify, at least to a certain extent, the various facial features of the face in the image. More specifically, the relative position, size, and/or shape of the forehead, eyes (and/or the corner of the eyes), nose (e.g., the tip of the nose), chin (e.g. tip of the chin), eyebrows, cheekbones, jaw, and facial contour may be identified and/or analyzed.

As shown in FIG. 4B, the facial pattern, including facial parameters, of the user's face may be identified in the image 402. More specifically, the facial parameter module 308 may be configured to generate facial parameters of the user's face based, at least in part, on the identified facial landmarks in the image. As shown, the facial parameters may include one or more key points 404 and associated edges 406 connecting one or more key points 404 to one another. For example, in the illustrated embodiment, edge 406(1) may be connecting adjacent key points 404(1), 404(2) to one another. The key points 404 and associated edges 406 form an overall facial pattern of a user based on the identified facial landmarks.

In one embodiment, the facial parameter module 308 may include custom, proprietary, known and/or after-developed facial parameter code (or instruction sets) that are generally well-defined and operable to generate the key points 404 and connecting edges 406 based on the identified facial landmarks (e.g. forehead, eyes, nose, mouth, chin, facial contour, etc.) according to statistical geometrical relation between one identified facial landmark, such as, for example, the forehead, and at least one other identified facial landmark, such as, for example, the eyes.

For example, in one embodiment, the key points 404 and associated edges 406 may be defined in bi-dimensional Cartesian coordinate system (the avatars are 2-D). More specifically, a key point 404 may be defined (e.g. coded) as {point, id, x, y}, where “point” represents node name, “id” represents index, and “x” and “y” are coordinates. An edge 406 may be defined (e.g. coded) as {edge, id, n, p1, p2, . . . , pn}, where “edge” represents node name, “id” represents edge index, “n” represents the number of key points contained (e.g. connected) by the edge 406, and p1-pn represent a point index of the edge 406. For example, the code set {edge, 0, 5, 0, 2, 1, 3, 0) may be understood to represent edge-0 includes (connects) 5 key points, wherein the connecting order of key points is key point 0 to key point 2 to key point 1 to key point 3 to key point 0.

FIG. 4C illustrates an example 2-D avatar 408 generated based on the identified facial landmarks and facial parameters, including the key points 404 and edges 406. As shown, the 2-D avatar 408 may include sketch lines that generally outline the shape of a user's face as well as key facial characteristics, such as the eyes, nose, mouth, eyebrows, and facial contour.

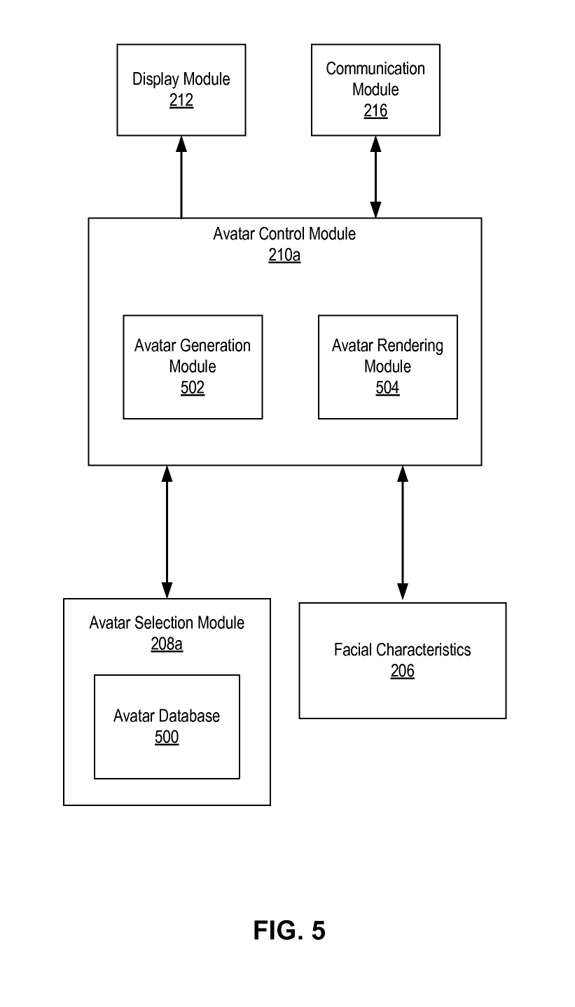

FIG. 5 illustrates an example avatar control module 210a and avatar selection module 208a consistent with various embodiments of the present disclosure. The avatar selection module 208a may be configured to allow a user of device 102 to select an avatar for display on a remote device. The avatar selection module 208 may include custom, proprietary, known and/or after-developed user interface construction code (or instruction sets) that are generally well-defined and operable to present different avatars to a user so that the user may select one of the avatars. In one embodiment, the avatar selection module 208a may be configured to allow a user of the device 102 to select one or more 2-D predefined avatars stored within an avatar database 500. The avatar selection module 208a may further be configured to allow a user to select to have a 2-D avatar generated, as generally shown and described with reference to FIGS. 4A-4C. A 2-D avatar that has been generated may be referred to as sketch-based 2-D avatar, wherein the key points and edges are generated from a user's face, as opposed to having predefined key points. In contrast, a predefined 2-D avatar may be referred to as a model-based 2-D avatar, wherein the key points are predefined and the 2-D avatar is not “custom” to the particular user's face.

As shown, the avatar control module 210a may include an avatar generation module 502 configured to generate a 2-D avatar in response to user selection indicating generation of an avatar from the avatar selection module 208a. The avatar generation module 502 may include custom, proprietary, known and/or after-developed avatar generation processing code (or instruction sets) that are generally well-defined and operable to generate a 2-D avatar based on the facial characteristics 206 detected by face detection module 204. More specifically, the avatar generation module 502 may generate a 2-D avatar 408 (shown in FIG. 4C) based on the identified facial landmarks and facial parameters, including the key points 404 and edges 406. Upon generation of the 2-D avatar, the avatar control module 210a may be further configured to transmit a copy of the generated 2-D avatar to the avatar selection module 208a to be stored in the avatar database 500.

As generally understood, the avatar generation module 502 may be configured to receive and generate a remote avatar selection based on remote avatar parameters. For example, the remote avatar parameters may include facial characteristics, including facial parameters (e.g. key points) of a remote user's face, wherein the avatar generation module 502 may be configured to generate a sketch-based avatar model. More specifically, the avatar generation module 502 may be configured to generate the remote user's avatar based, at least in part, on the key points and connecting one or more key points with edges. The generated remote user's avatar may then be displayed on the device 102.

The avatar control module 210a may further include an avatar rendering module 504 configured to provide adaptive rendering of a remote avatar selection based on remote avatar parameters. More specifically, the avatar control module 210 may include custom, proprietary, known and/or after-developed graphics processing code (or instruction sets) that are generally well-defined and operable to adaptively render the avatar 110 so as to appropriately fit on the display 108 and prevent distortion of the avatar 110 when displayed to a user.

In one embodiment, the avatar rendering module 504 may be configured to receive a remote avatar selection and associated remote avatar parameters. The remote avatar parameters may include facial characteristics, including facial parameters, of the remote avatar selection. The avatar rendering module 504 may be configured to identify display parameters of the remote avatar selection based, at least in part, on the remote avatar parameters. The display parameters may define a bounding box of the remote avatar selection, wherein the bounding box may be understood to refer to a default display size of the remote avatar 110. The avatar rendering module 504 may further be configured to identify display parameters (e.g. height and width) of the display 108, or display window, of device 102, upon which the remote avatar 110 is to be presented. The avatar rendering module 504 may further be configured to determine an avatar scaling factor based on the identified display parameters of the remote avatar selection and the identified display parameters of the display 108. The avatar scaling factor may allow the remote avatar 110 to be displayed on display 108 with proper scale (i.e. little or no distortion) and position (i.e. remote avatar 110 may be centered on display 108).

As generally understood, in the event the display parameters of the display 108 change (i.e. user manipulates device 102 so as to change view orientation from portrait to landscape or changes size of display 108), the avatar rendering module 504 may be configured to determine a new scaling factor based on the new display parameters of the display 108, upon which the display module 212 may be configured to display the remote avatar 110 on the display 108 based, as least in part, on the new scaling factor. Similarly, in the event that a remote user switches avatars during communication, the avatar rendering module 504 may be configured to determine a new scaling factor based on the new display parameters of the new remote avatar selection, upon which the display module 212 may be configured to display the remote avatar 110 on the display 108 based, as least in part, on the new scaling factor.

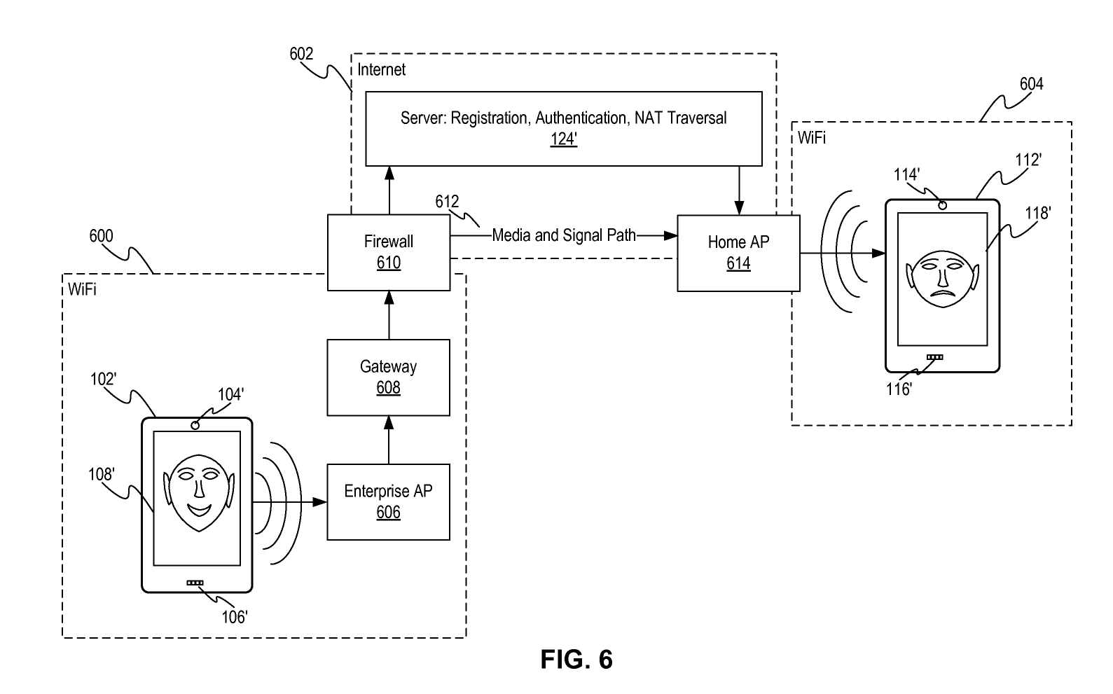

FIG. 6 illustrates an example system implementation in accordance with at least one embodiment. Device 102′ is configured to communicate wirelessly via WiFi connection 600 (e.g., at work), server 124′ is configured to negotiate a connection between devices 102′ and 112′ via Internet 602, and apparatus 112′ is configured to communicate wirelessly via another WiFi connection 604 (e.g., at home). In one embodiment, a device-to-device avatar-based video call application is activated in apparatus 102′. Following avatar selection, the application may allow at least one remote device (e.g., device 112′) to be selected. The application may then cause device 102′ to initiate communication with device 112′. Communication may be initiated with device 102′ transmitting a connection establishment request to device 112′ via enterprise access point (AP) 606. The enterprise AP 606 may be an AP usable in a business setting, and thus, may support higher data throughput and more concurrent wireless clients than home AP 614. The enterprise AP 606 may receive the wireless signal from device 102′ and may proceed to transmit the connection establishment request through various business networks via gateway 608. The connection establishment request may then pass through firewall 610, which may be configured to control information flowing into and out of the WiFi network 600.

The connection establishment request of device 102′ may then be processed by server 124′. The server 124′ may be configured for registration of IP addresses, authentication of destination addresses and NAT traversals so that the connection establishment request may be directed to the correct destination on Internet 602. For example, server 124′ may resolve the intended destination (e.g., remote device 112′) from information in the connection establishment request received from device 102′, and may route the signal to through the correct NATs, ports and to the destination IP address accordingly. These operations may only have to be performed during connection establishment, depending on the network configuration.

In some instances operations may be repeated during the video call in order to provide notification to the NAT to keep the connection alive. Media and Signal Path 612 may carry the video (e.g., avatar selection and/or avatar parameters) and audio information direction to home AP 614 after the connection has been established. Device 112′ may then receive the connection establishment request and may be configured to determine whether to accept the request. Determining whether to accept the request may include, for example, presenting a visual narrative to a user of device 112′ inquiring as to whether to accept the connection request from device 102′. Should the user of device 112′ accept the connection (e.g., accept the video call) the connection may be established. Cameras 104′ and 114′ may be configured to then start capturing images of the respective users of devices 102′ and 112′, respectively, for use in animating the avatars selected by each user. Microphones 106′ and 116′ may be configured to then start recording audio from each user. As information exchange commences between devices 102′ and 112′, displays 108′ and 118′ may display and animate avatars corresponding to the users of devices 10T and 112′.

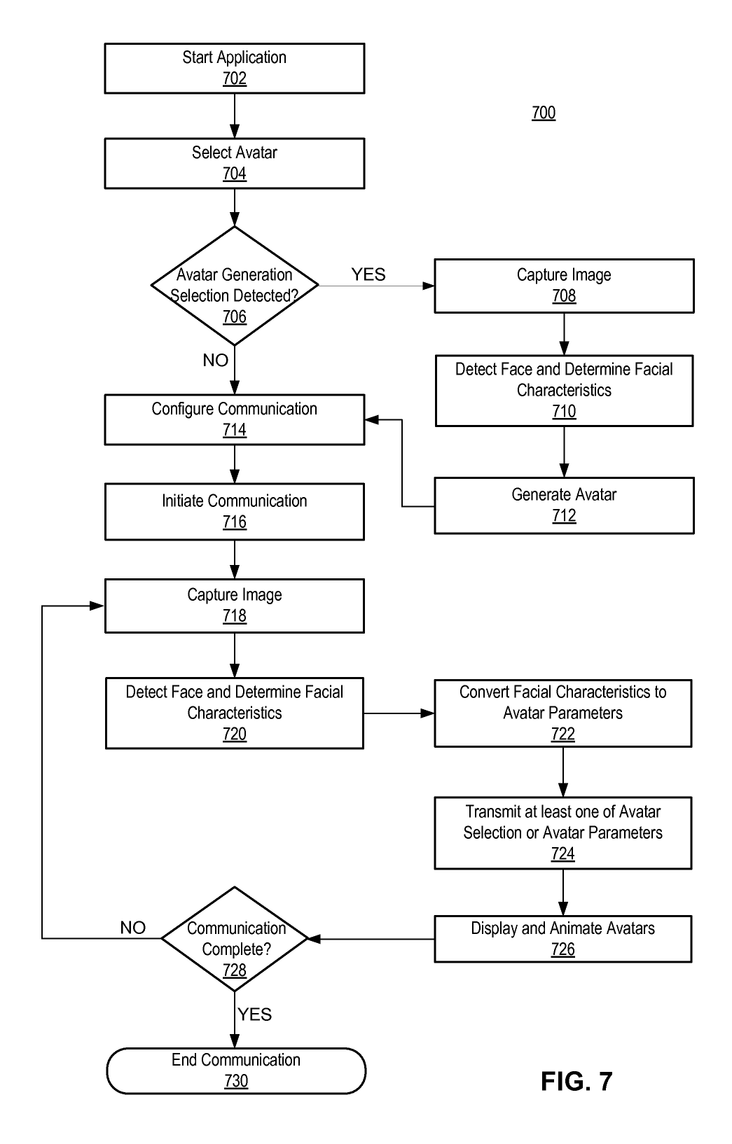

FIG. 7 is a flowchart of example operations in accordance with at least one embodiment. In operation 702 an application (e.g., an avatar-based voice call application) may be activated in a device. Activation of the application may be followed by selection of an avatar 704. Selection of an avatar may include an interface being presented by the application to the user, the interface allowing the user to browse and select from predefined avatar files stored in an avatar database. The interface may further allow a user to select to have an avatar generated. Whether a user decides to have an avatar generated may be determined at operation 706. If it is determined that the user selects to have an avatar generated, as opposed to selecting a predefined avatar, camera in the device may then begin capturing images in operation 708. The images may be still images or live video (e.g., multiple images captured in sequence). In operation 710 image analysis may occur starting with detection/tracking of a face/head in the image. The detected face may then be analyzed in order to extract facial characteristics (e.g., facial landmarks, facial parameters, facial expression, etc.). In operation 712, an avatar is generated based, at least in part, on the detected face/head position and/or facial characteristics.

After avatar selection, communications may be configured in operation 714. Communication configuration includes the identification of at least one remote device or a virtual space for participation in the video call. For example, a user may select from a list of remote users/devices stored within the application, stored in association with another system in the device (e.g., a contacts list in a smart phone, cell phone, etc.), stored remotely, such as on the Internet (e.g., in a social media website like Facebook, LinkedIn, Yahoo, Google+, MSN, etc.). Alternatively, the user may select to go online in a virtual space like Second Life.

In operation 716, communication may be initiated between the device and the at least one remote device or virtual space. For example, a connection establishment request may be transmitted to the remote device or virtual space. For the sake of explanation herein, it is assumed that the connection establishment request is accepted by the remote device or virtual space. A camera in the device may then begin capturing images in operation 718. The images may be still images or live video (e.g., multiple images captured in sequence). In operation 720 image analysis may occur starting with detection/tracking of a face/head in the image. The detected face may then be analyzed in order to extract facial characteristics (e.g., facial landmarks, facial parameters, facial expression, etc.). In operation 722 the detected face/head position and/or facial characteristics are converted into avatar parameters. Avatar parameters are used to animate and render the selected avatar on the remote device or in the virtual space. In operation 724 at least one of the avatar selection or the avatar parameters may be transmitted.

Avatars may be displayed and animated in operation 726. In the instance of device-to-device communication (e.g., system 100), at least one of remote avatar selection or remote avatar parameters may be received from the remote device. An avatar corresponding to the remote user may then be displayed based on the received remote avatar selection, and may be animated and/or rendered based on the received remote avatar parameters. In the instance of virtual place interaction (e.g., system 126), information may be received allowing the device to display what the avatar corresponding to the device user is seeing.

A determination may then be made in operation 728 as to whether the current communication is complete. If it is determined in operation 728 that the communication is not complete, operations 718-726 may repeat in order to continue to display and animate an avatar on the remote apparatus based on the analysis of the user's face. Otherwise, in operation 730 the communication may be terminated. The video call application may also be terminated if, for example, no further video calls are to be made.

While FIG. 7 illustrates various operations according to an embodiment, it is to be understood that not all of the operations depicted in FIG. 7 are necessary for other embodiments. Indeed, it is fully contemplated herein that in other embodiments of the present disclosure, the operations depicted in FIG. 7 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

According to one aspect, there is provided a system for generation, rendering and animation during communication between a first user device and a remote user device. The system includes a camera configured to capture images, a communication module configured to initiate and establish communication between the first and the remote user devices and to transmit and receive information between the first and the remote user devices, and one or more storage mediums having stored thereon, individually or in combination, instructions that when executed by one or more processors result in one or more operations. The operations include selecting at least one of a model-based two-dimensional (2-D) avatar and a sketch-based 2-D avatar for use during communication, initiating communication, capturing an image, detecting a face in the image, determining facial characteristics from the face, converting the facial characteristics to avatar parameters, and transmitting at least one of the avatar selection and avatar parameters.

Another example system includes the foregoing components and determining facial characteristics from the face includes detecting and identifying facial landmarks in the face. The facial landmarks including at least one of a forehead, chin, eyes, nose, mouth, and facial contour of the face in the image. The determining facial characteristics from the face further includes generating facial parameters based, at least in part, on the identified facial landmarks. The facial parameters include one or more key points and edges forming connections between at least two of the one or more key points.

Another example system includes the foregoing components and the avatar selection and avatar parameters are used to generate an avatar on a remote device, the avatar being based on the facial characteristics.

Another example system includes the foregoing components and the avatar selection and avatar parameters are used to generate an avatar in a virtual space, the avatar being based on the facial characteristics.

Another example system includes the foregoing components and the instructions that when executed by one or more processors result in the following additional operation of receiving at least one of a remote avatar selection and remote avatar parameters.

Another example system includes the foregoing components and further including a display, wherein the instructions that when executed by one or more processors result in the following additional operations of rendering the remote avatar selection based on the remote avatar parameters to allow an avatar based on the remote avatar selection to be displayed with little or no distortion and displaying the avatar based on the rendered remote avatar selection.

Another example system includes the foregoing components and the instructions that when executed by one or more processors result in the following additional operations of animating the displayed avatar based on the remote avatar parameters.

According to one aspect, there is provided an apparatus for avatar generation, rendering and animation during communication between a first user device and a remote user device. The apparatus includes a communication module configured to initiate and establish communication between the first and the remote user devices, an avatar selection module configured to allow a user to select at least one of a model-based two-dimensional (2-D) avatar and a sketch-based 2-D avatar for use during communication, a face detection module configured to detect a facial region in an image of the user and to detect and identify one or more facial characteristics of the face, and an avatar control module configured to convert the facial characteristics to avatar parameters. The communication module is configured to transmit at least one of the avatar selection and avatar parameters.

Another example apparatus includes the foregoing components and the face detection module includes a landmark detection module configured to identify facial landmarks of the facial region in the image, the facial landmarks comprise at least one of a forehead, chin, eyes, nose, mouth, and facial contour of the face. The face detection module further includes a facial parameter module configured to generate facial parameters based, at least in part, on the identified facial landmarks, the facial parameters comprise one or more key points and edges forming connections between at least two of the one or more key points.

Another example apparatus includes the foregoing components and the avatar control module is configured to generate the sketch-based 2D avatar based, at least in part, on the facial parameters.

Another example apparatus includes the foregoing components and the avatar selection and avatar parameters are used to generate an avatar on the remote device, the avatar being based on the facial characteristics.

Another example apparatus includes the foregoing components and the communication module is configured to receive at least one of a remote avatar selection and remote avatar parameters.

Another example apparatus includes the foregoing components and further includes a display configured to display an avatar based on the remote avatar selection.

Another example apparatus includes the foregoing components and further includes an avatar rendering module configured to render the remote avatar selection based on the remote avatar parameters to allow the avatar based on the remote avatar selection to be displayed with little or no distortion.

Another example apparatus includes the foregoing components and the avatar control module is configured to animate the displayed avatar based on the remote avatar parameters.

According to another aspect there is provided a method for avatar generation, rendering and animation. The method includes selecting at least one of a model-based two-dimensional (2-D) avatar and a sketch-based 2-D avatar for use during communication, initiating communication, capturing an image, detecting a face in the image, determining facial characteristics from the face, converting the facial characteristics to avatar parameters, and transmitting at least one of the avatar selection and avatar parameters.

Another example method includes the foregoing operations and determining facial characteristics from the face includes detecting and identifying facial landmarks in the face. The facial landmarks including at least one of a forehead, chin, eyes, nose, mouth, and facial contour of the face in the image. The determining facial characteristics from the face further includes generating facial parameters based, at least in part, on the identified facial landmarks. The facial parameters include one or more key points and edges forming connections between at least two of the one or more key points.

Another example method includes the foregoing operations and the avatar selection and avatar parameters are used to generate an avatar on a remote device, the avatar being based on the facial characteristics.

Another example method includes the foregoing operations and the avatar selection and avatar parameters are used to generate an avatar in a virtual space, the avatar being based on the facial characteristics.

Another example method includes the foregoing operations and the instructions that when executed by one or more processors result in the following additional operation of receiving at least one of a remote avatar selection and remote avatar parameters.

Another example method includes the foregoing operations and further including a display, wherein the instructions that when executed by one or more processors result in the following additional operations of rendering the remote avatar selection based on the remote avatar parameters to allow an avatar based on the remote avatar selection to be displayed with little or no distortion and displaying the avatar based on the rendered remote avatar selection.

Another example method includes the foregoing operations and the instructions that when executed by one or more processors result in the following additional operations of animating the displayed avatar based on the remote avatar parameters.

According to another aspect there is provided at least one computer accessible medium including instructions stored thereon. When executed by one or more processors, the instructions may cause a computer system to perform operations for avatar generation, rendering and animation. The operations include selecting at least one of a model-based two-dimensional (2-D) avatar and a sketch-based 2-D avatar for use during communication, initiating communication, capturing an image, detecting a face in the image, determining facial characteristics from the face, converting the facial characteristics to avatar parameters, and transmitting at least one of the avatar selection and avatar parameters.

Another example computer accessible medium includes the foregoing operations and determining facial characteristics from the face includes detecting and identifying facial landmarks in the face. The facial landmarks including at least one of a forehead, chin, eyes, nose, mouth, and facial contour of the face in the image. The determining facial characteristics from the face further includes generating facial parameters based, at least in part, on the identified facial landmarks. The facial parameters include one or more key points and edges forming connections between at least two of the one or more key points.

Another example computer accessible medium includes the foregoing operations and the avatar selection and avatar parameters are used to generate an avatar on a remote device, the avatar being based on the facial characteristics.

Another example computer accessible medium includes the foregoing operations and the avatar selection and avatar parameters are used to generate an avatar in a virtual space, the avatar being based on the facial characteristics.

Another example computer accessible medium includes the foregoing operations and the instructions that when executed by one or more processors result in the following additional operation of receiving at least one of a remote avatar selection and remote avatar parameters.

Another example computer accessible medium includes the foregoing operations and further including a display, wherein the instructions that when executed by one or more processors result in the following additional operations of rendering the remote avatar selection based on the remote avatar parameters to allow an avatar based on the remote avatar selection to be displayed with little or no distortion and displaying the avatar based on the rendered remote avatar selection.

Another example computer accessible medium includes the foregoing operations and the instructions that when executed by one or more processors result in the following additional operations of animating the displayed avatar based on the remote avatar parameters.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-23. (canceled)

24. A system for avatar generation, rendering and animation during communication between a first user device and a remote user device, said system comprising:
a camera configured to capture images;
a communication module configured to initiate and establish communication between said first and said remote user devices and to transmit and receive information between said first and said remote user devices; and
one or more storage mediums having stored thereon, individually or in combination, instructions that when executed by one or more processors result in the following operations comprising:
selecting at least one of a model-based two-dimensional (2-D) avatar and a sketch-based 2-D avatar for use during communication;
initiating communication;
capturing an image;
detecting a face in said image;
determining facial characteristics from said face;
converting said facial characteristics to avatar parameters;
transmitting at least one of said avatar selection and avatar parameters.

25. The system of claim 24, wherein determining facial characteristics from said face comprises:
detecting and identifying facial landmarks in said face, said facial landmarks comprising at least one of a forehead, chin, eyes, nose, mouth, and facial contour of said face in said image; and
generating facial parameters based, at least in part, on said identified facial landmarks, said facial parameters comprising one or more key points and edges forming connections between at least two of said one or more key points.

26. The system of claim 24, wherein said avatar selection and avatar parameters are used to generate an avatar on a remote device, said avatar being based on said facial characteristics.

27. The system of claim 24, wherein said avatar selection and avatar parameters are used to generate an avatar in a virtual space, said avatar being based on said facial characteristics.

28. The system of claim 24, wherein the instructions that when executed by one or more processors result in the following additional operations:
receiving at least one of a remote avatar selection and remote avatar parameters.

29. The system of claim 29, further comprising a display, wherein the instructions that when executed by one or more processors result in the following additional operations:
rendering said remote avatar selection based on said remote avatar parameters to allow an avatar based on said remote avatar selection to be displayed with little or no distortion; and
displaying said avatar based on said remote avatar selection.

30. The system of claim 30, wherein the instructions that when executed by one or more processors result in the following additional operations:
animating said displayed avatar based on said remote avatar parameters.

31. An apparatus for avatar generation, rendering and animation during communication between a first user device and a remote user device, said apparatus comprising:
a communication module configured to initiate and establish communication between said first and said remote user devices;
an avatar selection module configured to allow a user to select at least one of a model-based two-dimensional (2-D) avatar and a sketch-based 2-D avatar for use during communication;
a face detection module configured to detect a facial region in an image of said user and to detect and identify one or more facial characteristics of said face; and
an avatar control module configured to convert said facial characteristics to avatar parameters;
wherein said communication module is configured to transmit at least one of said avatar selection and avatar parameters.

32. The apparatus of claim 31, wherein said face detection module comprises:
a landmark detection module configured to identify facial landmarks of said facial region in said image, said facial landmarks comprising at least one of a forehead, chin, eyes, nose, mouth, and facial contour of said face; and
a facial parameter module configured to generate facial parameters based, at least in part, on said identified facial landmarks, said facial parameters comprising one or more key points and edges forming connections between at least two of said one or more key points.

33. The apparatus of claim 32, wherein said avatar control module is configured to generate said sketch-based 2D avatar based, at least in part, on said facial parameters.

34. The apparatus of claim 31, wherein said avatar selection and avatar parameters are used to generate an avatar on said remote device, said avatar being based on said facial characteristics.

35. The apparatus of claim 31, wherein said communication module is configured to receive at least one of a remote avatar selection and remote avatar parameters.

36. The apparatus of claim 35, further comprising:
an avatar rendering module configured to render said remote avatar selection based on said remote avatar parameters to allow said avatar based on said remote avatar selection to be displayed with little or no distortion; and
a display configured to display said avatar based on said rendered remote avatar selection.

37. The apparatus of claim 35, wherein said avatar control module is configured to animate said displayed avatar based on said remote avatar parameters.

38. A method for avatar generation, rendering and animation, said method comprising:
selecting at least one of a model-based two-dimensional (2-D) avatar and a sketch-based 2-D avatar for use during communication;
initiating communication;
capturing an image;
detecting a face in said image;
determining facial characteristics from said face;
converting said facial characteristics to avatar parameters;
transmitting at least one of said avatar selection and avatar parameters.

39. The method of claim 38, wherein determining facial characteristics from said face comprises:
detecting and identifying facial landmarks in said face, said facial landmarks comprising at least one of a forehead, chin, eyes, nose, mouth, and facial contour of said face in said image; and
generating facial parameters based, at least in part, on said identified facial landmarks, said facial parameters comprising key points and edges forming connections between one or more key points.

40. The method of claim 38, wherein said avatar selection and avatar parameters are used to generate an avatar on a remote device, said avatar being based on said facial characteristics.

41. The method of claim 38, further comprising receiving at least one of a remote avatar selection and remote avatar parameters.

42. The method of claim 41, further comprising:
rendering said remote avatar selection based on said remote avatar parameters to allow an avatar based on said remote avatar selection to be displayed with little or no distortion; and
displaying said avatar based on said rendered remote avatar selection.

43. The method of claim 41, further comprising animating said displayed avatar based on said remote avatar parameters.
